(19) United States
(12) Patent Application Publication
(10) Pub. No.: US 2007/0072138 A1
(43) Pub. Date: Mar. 29, 2007

(54) Atmosphere-control-system design programs and methods

(75) Inventor: Michael Beisheim, Roswell, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Exhausto, Inc.

(21) Appl. No.: 11/233,851

(22) Filed: Sep. 23, 2005

(51) Int. Cl. A01G 13/06

(52) U.S. Cl. 431/18

(57) ABSTRACT

Provided are methods for an atmosphere-control-system design using computer software. The methods include receiving a plurality of inputs from a user and retrieving data from a database. Performance parameters are calculated, system components are selected, and a report is generated for the user. Also provided is a computer program product, in a computer readable medium, for providing design data for an atmosphere-control-system. The product includes instructions configured to receive inputs from a user, instructions configured to retrieve data from a database, instructions configured to calculate a variety of system performance values, instructions configured to select system components; and instructions configured to generate a report for the user.

### TECHNICAL FIELD

The present disclosure is generally related to vent and flue system design.

### BACKGROUND

Designing an atmosphere control system has heretofore required significant knowledge of mechanical engineering principles. Additionally, the performance parameters associated with atmosphere control system components, as well as the devices and systems that necessitate the installation of an atmosphere control system, need to be known. For example, systems that include significant combustion processes using, for example, coal, propane, natural gas, or coke, have a combustion air requirement to ensure that the oxygen and fuel mixture is maintained at a proper ratio. Additionally, systems such as these may require a properly designed vent system to exhaust the gases associated with combustion or other processes. As should be understood, gathering the requisite data, performing the calculations, comparing system alternatives, and communicating the design results in a useful format requires significant temporal and financial resources.

### SUMMARY

Programs and methods for atmosphere-control-system design are provided. Briefly described, one embodiment of such a system can be implemented as a computer program product, in a computer readable medium, for providing design data for an atmosphere-control-system. The computer program product comprises: instructions configured to receive a plurality of inputs from a user; instructions configured to retrieve, from a database, data corresponding to the plurality of inputs; instructions configured to calculate a variety of system performance values; instructions configured to select a plurality of system components; and instructions configured to generate a report for the user.

Embodiments of the present disclosure can also be viewed as providing methods for designing an atmosphere-control-system using computer software. In this regard, an embodiment of a method for providing an atmosphere-control-system design using computer software can be broadly summarized by the following steps: receiving a plurality of inputs, corresponding to a proposed atmospheric control system, from a user; retrieving data from a database; calculating a plurality of performance parameters; selecting a plurality of system components; and generating a report for the user.

Another embodiment of a computer readable medium has a computer program for providing an atmosphere-control-system design, the program for performing the steps of: validating an identity of a user; receiving data from the user; retrieving data from a database; calculating system parameters and configuration values; selecting multiple system components; and generating a report.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a block diagram illustrating an exemplary embodiment of a method for providing an atmosphere-control-system design using computer software.

FIG. 2 is a block diagram illustrating an exemplary embodiment of a receiving function as disclosed in FIG. 1.

FIG. 3 is a block diagram illustrating an exemplary embodiment of a retrieving function as disclosed in FIG. 1.

FIG. 4 is a block diagram illustrating an exemplary embodiment of a calculating function as disclosed in FIG. 1.

FIG. 5 is a block diagram illustrating an exemplary embodiment of a selecting function as disclosed in FIG. 1.

FIG. 6 is a block diagram illustrating an exemplary embodiment of a generating function as disclosed in FIG. 1.

FIG. 7 is a block diagram illustrating an exemplary configuration of inputs and outputs for a software application.

FIG. 8 is a block diagram illustrating an alternative embodiment of a configuration of inputs and outputs for a software application.

FIG. 9 is a block diagram illustrating an exemplary screen representation of an embodiment of an atmosphere-control-system design program general tab.

FIG. 10 is a block diagram illustrating an exemplary screen representation of an embodiment of an atmosphere-control-system design program details tab.

FIG. 11 is a block diagram illustrating an exemplary screen representation of an embodiment of an atmosphere-control-system design program quote tab.

FIG. 12 is a block diagram illustrating an exemplary representation of an embodiment of an atmosphere-control-system design program system layout input screen.

FIG. 13 is a block diagram illustrating an exemplary representation of an embodiment of a results tab on a vent results screen of an atmosphere-control-system design program.

FIG. 14 is a block diagram illustrating an exemplary representation of an embodiment of a components tab on a vent results screen of an atmosphere-control-system design program.

FIG. 15 is a block diagram illustrating an exemplary representation of an embodiment of a documents tab on a vent results screen of an atmosphere-control-system design program.

FIG. 16 is a block diagram illustrating an exemplary representation of an embodiment of a stack selections tab on a vent results screen of an atmosphere-control-system design program.

FIG. 17 is a block diagram illustrating an exemplary representation of an embodiment of an appliances tab on a vent results screen of an atmosphere-control-system design program.

FIG. 18 is a block diagram illustrating an exemplary representation of an embodiment of a balancing baffles tab on a vent results screen of an atmosphere-control-system design program.

FIG. 19 is a block diagram illustrating an exemplary representation of an embodiment of a code issues tab on a vent results screen of an atmosphere-control-system design program.

FIG. 20 is a block diagram illustrating an exemplary representation of an embodiment of a cost comparison tab on a vent results screen of an atmosphere-control-system design program.

FIG. 21 is a block diagram illustrating an exemplary representation of an embodiment of a combustion air tab on a vent results screen of an atmosphere-control-system design program.

FIG. 22 is a block diagram illustrating an exemplary representation of an embodiment of a print options tab on a vent results screen of an atmosphere-control-system design program.

FIG. 23 is a block diagram illustrating an exemplary embodiment of a computer program product.

### DETAILED DESCRIPTION

Embodiments of the present disclosure facilitate the design of an atmosphere control system by a user who does not have specific knowledge of system components and appliances and their corresponding operating characteristics. Additionally, a user, such as a system designer, can complete a system design by providing information from a location remote to an atmosphere-control-system design program. Other than general installation-site-specific data, such as geographical data and system layout information, the program either calculates or retrieves the information required to design an atmosphere control system. Additionally, the program generates system design reports serve a variety of needs. For example, some reports can include comparisons of different system configurations. Other reports provide data for submitting bids or proposals to design and/or install the system. Further, reports can be generated that include a bill of materials.

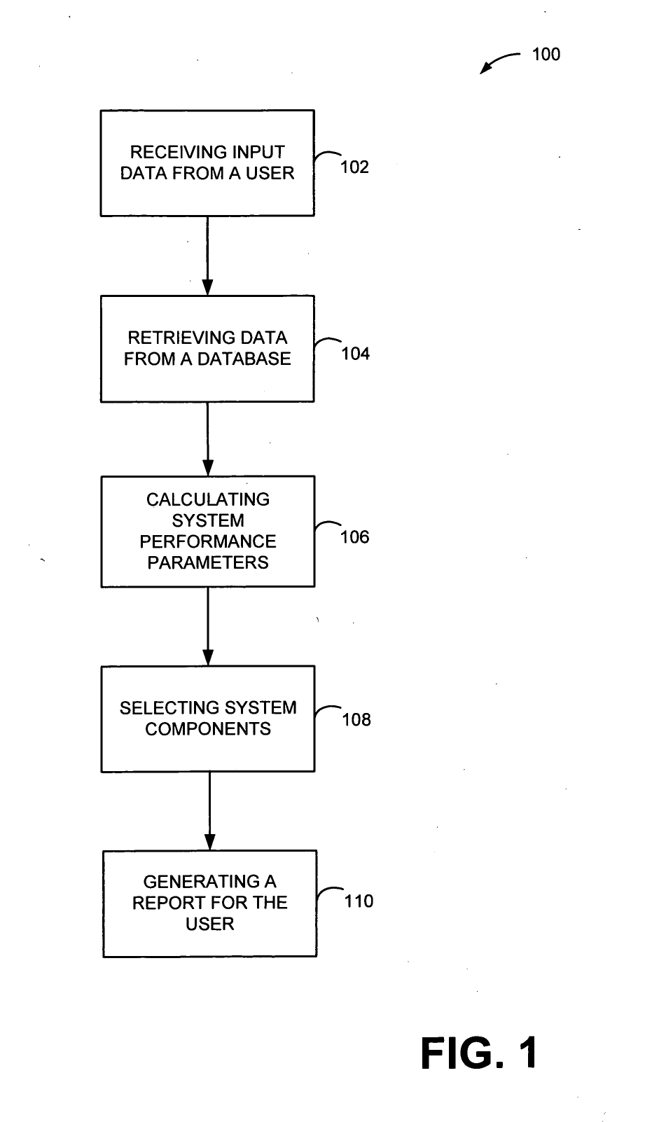

Reference is made to FIG. 1, which is a block diagram illustrating an exemplary embodiment of a method 100 for providing an atmosphere-control-system design using computer software. As shown in FIG. 1, input data is received from a user in block 102. Input data can include, for example, a geographical location of a proposed control system, the quantity of appliances in the proposed control system, system dimensional information, and appliance specific data. Additionally, the user can provide the input data through a local terminal or from a remote location using any number of wired or wireless networking or communication technologies. Database data, corresponding to the input data received from the user, is retrieved from a database in block 104. The retrieved data can include, for example, elevation and ambient temperature data corresponding to a geographical location and appliance characteristic data corresponding to the types of appliances as provided by the user. The data retrieved from the database may be retrieved locally or remotely using any combination of wired or wireless networking or communication technologies.

After receiving the input data and retrieving database data, system performance parameters are calculated in block 106. Exemplary parameters calculated can include volume, pressure, and velocity values of the proposed control system. Additionally, system dimensional characteristics can be calculated including, for example, duct dimensions or diameters. Resistance values associated with each system component can be calculated and an estimated system draft value can be calculated. Calculations herein can be based on known engineering practices and can be found in the 2000 ASHRAE Systems and Equipment Handbook, which is incorporated herein by reference in its entirety. For example, an initial duct diameter value can be determined by the equation:
dᵢ=((144×4w)/(3600πρₘV))^{0.5},
where dᵢ is the duct diameter, w is the mass flow rate, V is a desired gas velocity estimate, and ρₘ is the gas density. The mass flow rate can be determined by the equation:
w=IM/1000,
where I is the appliance heat input and M is the ratio of mass flow to heat input. The value of I is determined by the appliance data and the value of M is determined by the fuel composition and percentage of excess air in the duct. The gas density can be determined by the equation:
ρₘ=1.325(B/Tₘ),
where B is the local barometric pressure and Tₘ is the mean flue gas temperature at average system conditions. Once an initial value for the duct diameter is calculated, an actual duct size can be selected from a database. The selected duct diameter can then be utilized in the first equation to calculate actual gas velocity in the duct as shown by:
V=(144×4w)/(3600πρₘdᵢ²).

The system pressure loss due to flow can be calculated using the equation:
Δp=(kρₘV²)/(10.4g),
where k is a system resistance coefficient based on piping and fittings, ρₘ is the gas density, as calculated above, V is the system gas velocity, as calculated above, and g is the gravitational constant. The system pressure can then be utilized to determine the volumetric flow rate using the equation:
Q=5.2dᵢ²(ΔpTₘ/kB)^{0.5}.
The theoretical draft value for a duct can also be calculated utilizing the equation:
Dt=0.22554BH((1/Tₒ)−(1/Tₘ)),
where Tₒ is the ambient temperature retrieved from a database and H is the height of the duct above the inlet. One of ordinary skill in the art knows or will know that the above calculations and equations are merely exemplary and are not intended to limit the spirit or scope of the claims in any way.

System components are selected in block 108, corresponding to selected system performance parameters. The system components can include, but are not limited to, fans, vents, baffles, and any combination thereof. A report is generated for the user in block 110. The report can include, but is not limited to, an equipment listing for the proposed atmospheric control system, a cost estimate submission document for use in bidding jobs as a contractor or subcontractor, a list of potential code violations and a vent cost comparison, which can include comparative data corresponding to an alternative system design. The report can be generated as a printable electronic computer file and can be customized to include various combinations of report segments.

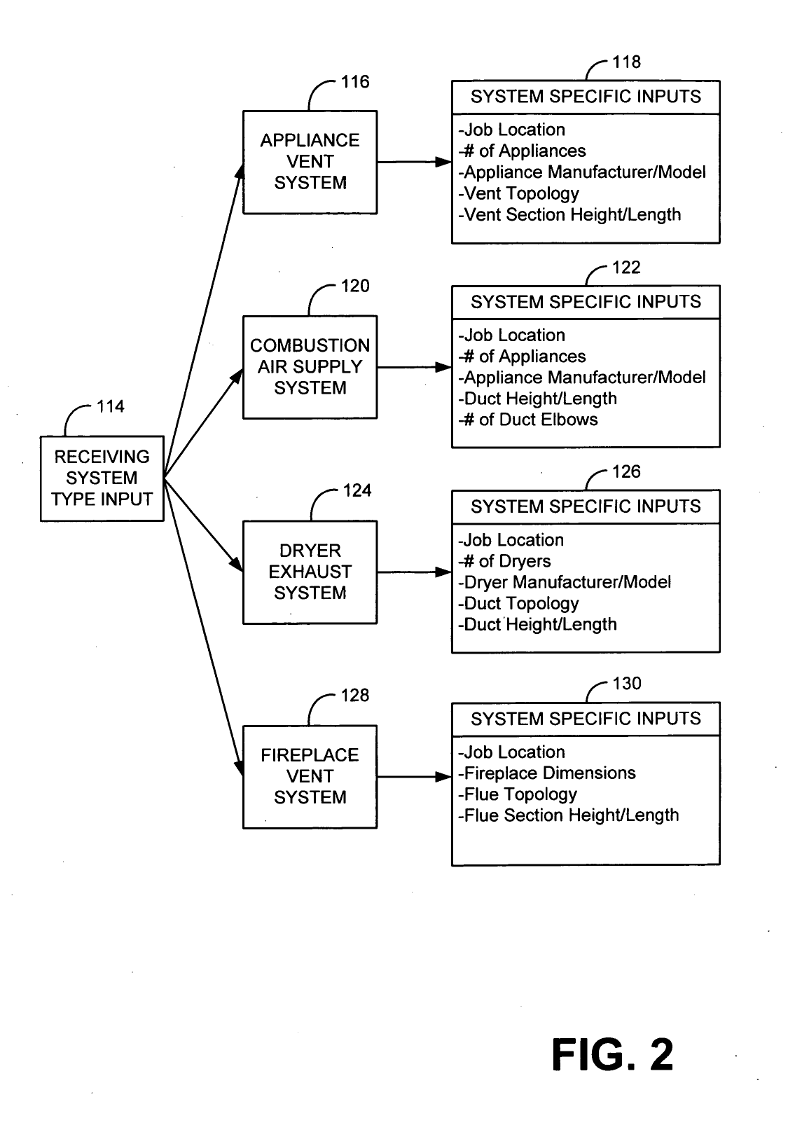

Reference is now made to FIG. 2, which is a block diagram illustrating an exemplary embodiment of a receiving function as disclosed in FIG. 1. Before determining required inputs for a particular system design, the receiving function determines the receiving system type in block 114. Non-limiting examples of system types include an appliance vent system 116, a combustion air supply system 120, a dryer exhaust system 124, and a fireplace vent system 128. Depending on the system type, the system specific inputs supplied by the user will vary. For example, in an appliance vent system 116, the system specific inputs 118 include, for example, job location, number of appliances, appliance manufacturer and model information, vent topology, and vent section height and length. Similarly, for combustion air supply system 120, the system specific inputs 122 include, for example, job location, number of appliances, appliance manufacturer and model data, duct height, length, and number of duct elbows. Further, in the case of a dryer exhaust system 124, the system specific inputs 126 include, for example, job location, number of dryers, dryer manufacturer and model data, duct topology, and duct length and height data. A fireplace vent system 128 can utilize system specific inputs 130, including, for example, job location, fireplace dimensions, flue topology, a flue section height and length data.

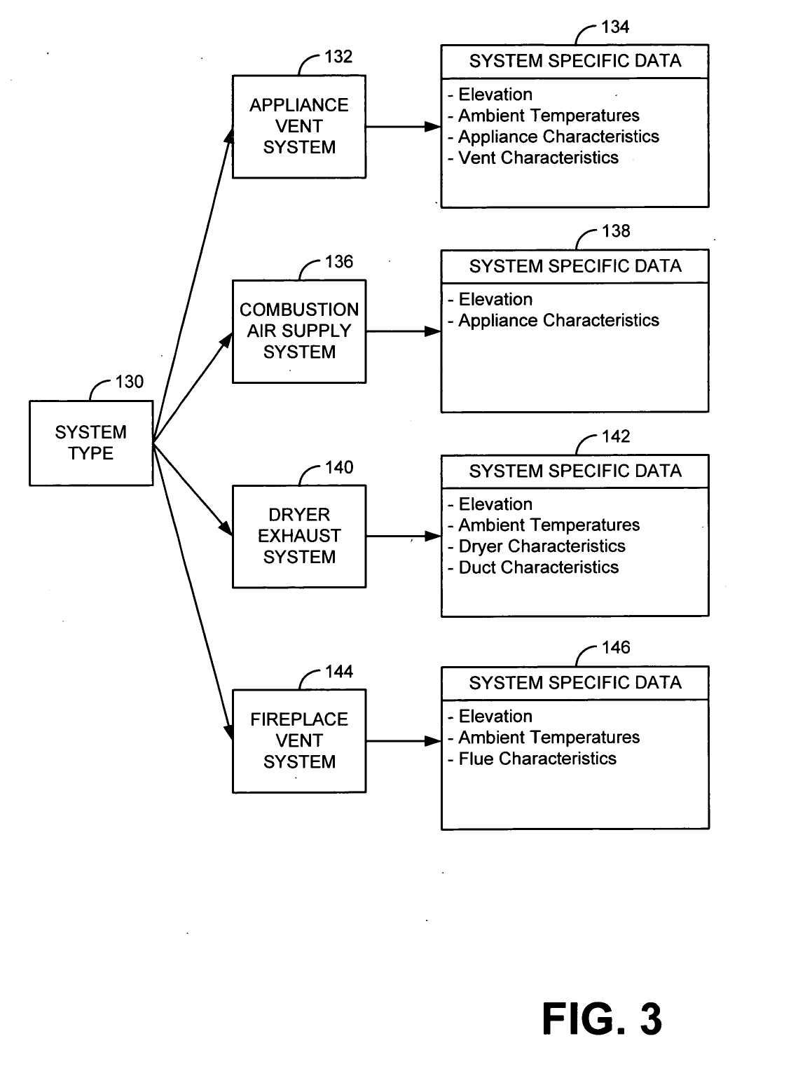

Reference is now made to FIG. 3, which is a block diagram illustrating an exemplary embodiment of a retrieving function as disclosed in FIG. 1. As discussed above, in reference to FIG. 2, the system specific data will vary depending on the system type 130. The system types, as discussed above, can, for example, be an appliance vent system 132, a combustion air supply system 136, a dryer exhaust system 140, or a fireplace vent system 144. In the case of an appliance vent system 132, the retrieved system specific data 134 includes, but is not limited to, elevation, ambient temperatures, appliance characteristics, and vent characteristics. In the case of a combustion air supply system 136, the retrieved system specific data 138 includes, but is not limited to, elevation and appliance characteristics. Where the control system is for a dryer exhaust system 140, the retrieved system specific data 142 includes, for example, elevation, ambient temperatures, dryer characteristics, and duct characteristics. The retrieved system specific data 146 corresponding to a fireplace vent system 144 includes, but is not limited to, elevation, ambient temperatures and flue characteristics.

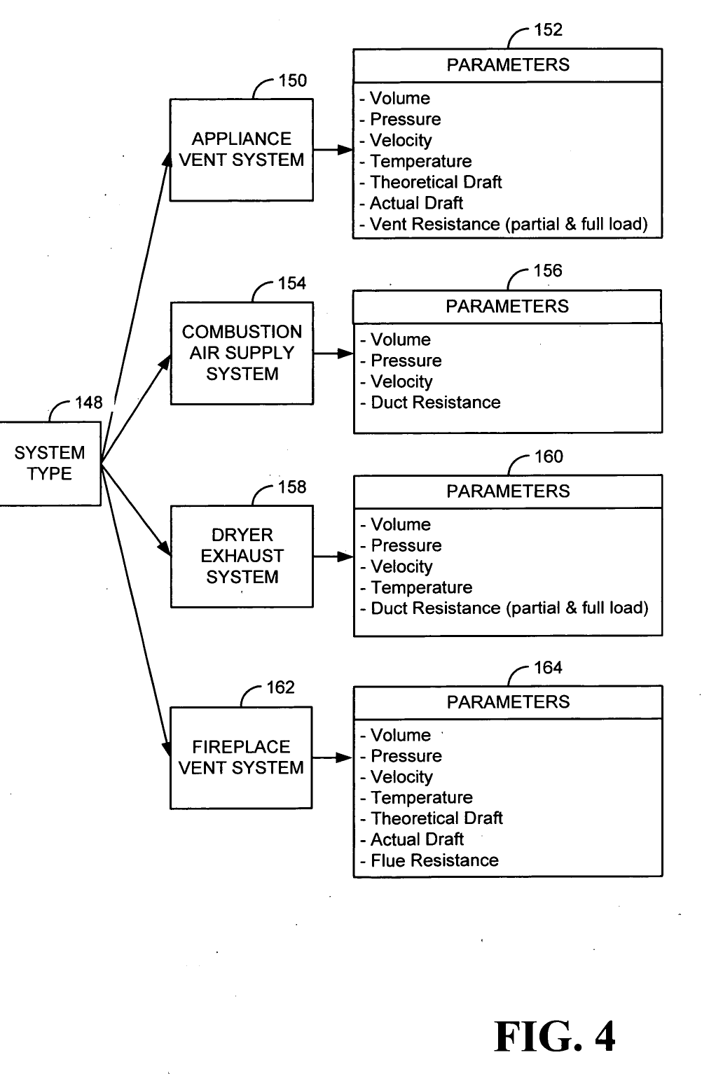

Reference is now made to FIG. 4, which is a block diagram illustrating an exemplary embodiment of a calculating function as disclosed in FIG. 1. Consistent with other atmosphere control system design steps, the calculated data will vary depending on the system type 148. The system types, as discussed above, can, for example, be an appliance vent system 150, a combustion air supply system 154, a dryer exhaust system 158, or a fireplace vent system 162. In the case of an appliance vent system 150, the calculated data 152 includes, but is not limited to, volume, pressure, velocity, temperature, theoretical draft, actual draft, and vent resistance under both full and partial loading. In the case of a combustion air supply system 154, the calculated data 156 includes, but is not limited to, volume, pressure, velocity, and duct resistance. Where the control system is for a dryer exhaust system 158, the calculated data 160 includes, for example, volume, pressure, velocity, temperature, and vent resistance under both full and partial loading. The calculated data 164 corresponding to a fireplace vent system 162 includes, but is not limited to, volume, pressure, velocity, temperature, theoretical draft, actual draft, and vent resistance under both full and partial loading.

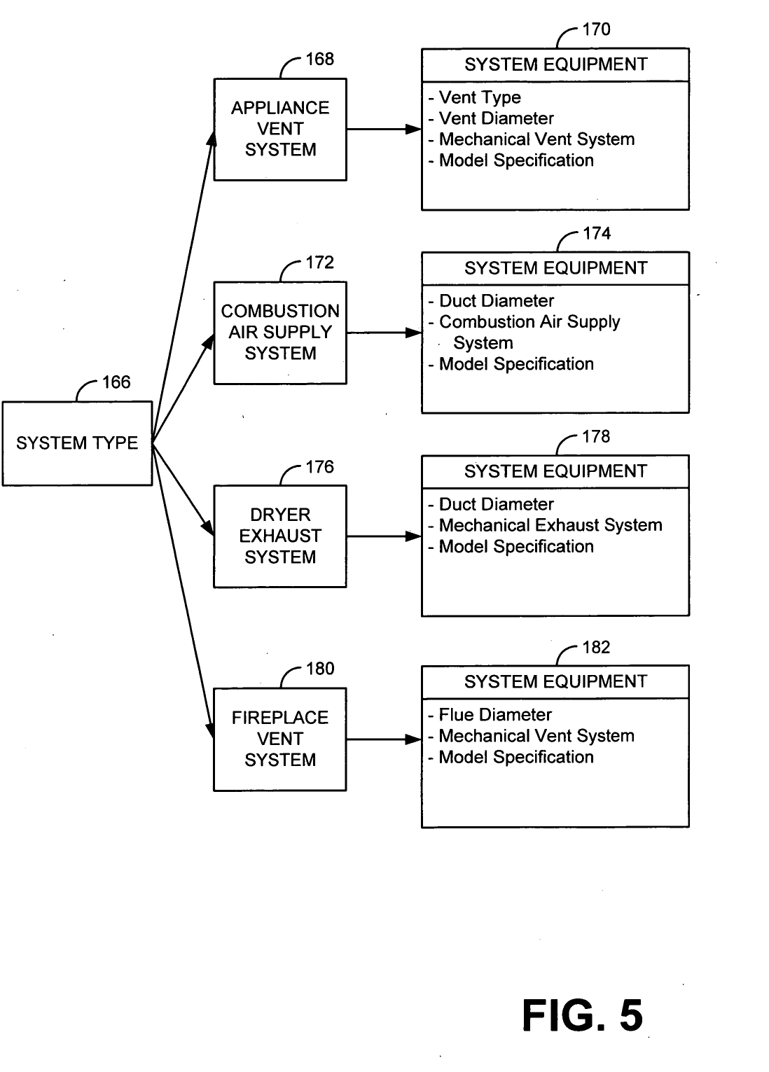

Reference is now made to FIG. 5, which is a block diagram illustrating an exemplary embodiment of a selecting function as disclosed in FIG. 1. Consistent with other atmosphere control system design steps, the selecting function will vary depending on the system type 166. The system types, as discussed above, can, for example, be an appliance vent system 168, a combustion air supply system 172, a dryer exhaust system 176, or a fireplace vent system 180. In the case of an appliance vent system 168, the selected system equipment 170 includes, but is not limited to, vent type, vent diameter, mechanical vent system, and a model specification. In the case of a combustion air supply system 136, the selected system equipment 174 includes, but is not limited to, duct diameter, combustion air supply system, and a model specification. Where the control system is for a dryer exhaust system 176, the selected system equipment 178 includes, for example, duct diameter, mechanical exhaust system, and a model specification. The selected system equipment 182 corresponding to a fireplace vent system 180 includes, but is not limited to, flue diameter, mechanical exhaust system, and a model specification.

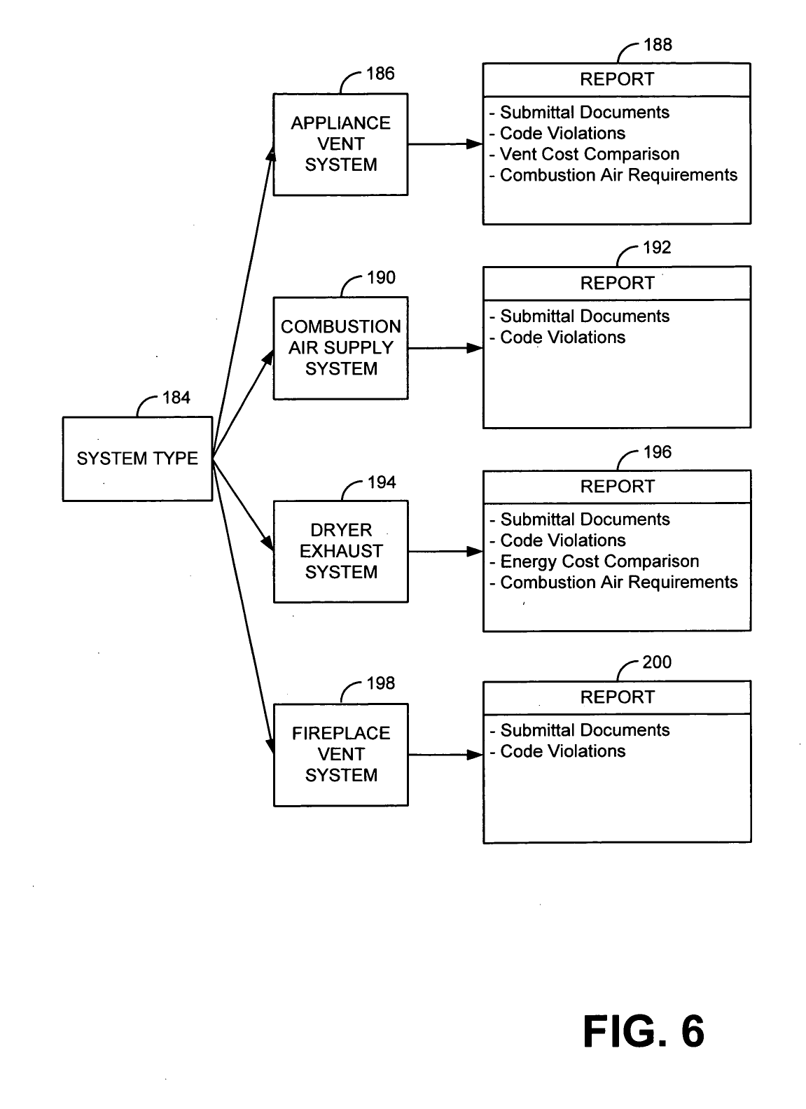

Reference is now made to FIG. 6, which is a block diagram illustrating an exemplary embodiment of a generating function as disclosed in FIG. 1. Consistent with other atmosphere control system design steps, the generated report content will vary depending on the system type 184. The system types, as discussed above, can, for example, be an appliance vent system 186, a combustion air supply system 190, a dryer exhaust system 194, or a fireplace vent system 198. In the case of an appliance vent system 186, the report 188 includes, but is not limited to, submittal documents, code violations, vent cost comparisons, and combustion air requirements. In the case of a combustion air supply system 190, the report 192 includes, but is not limited to, submittal documents and code violations. Where the control system is for a dryer exhaust system 194, the report 196 includes, for example, submittal documents, code violations, an energy cost comparison, and combustion air requirements. The report 200 corresponding to a fireplace vent system 198 includes, but is not limited to, submittal documents and code violations.

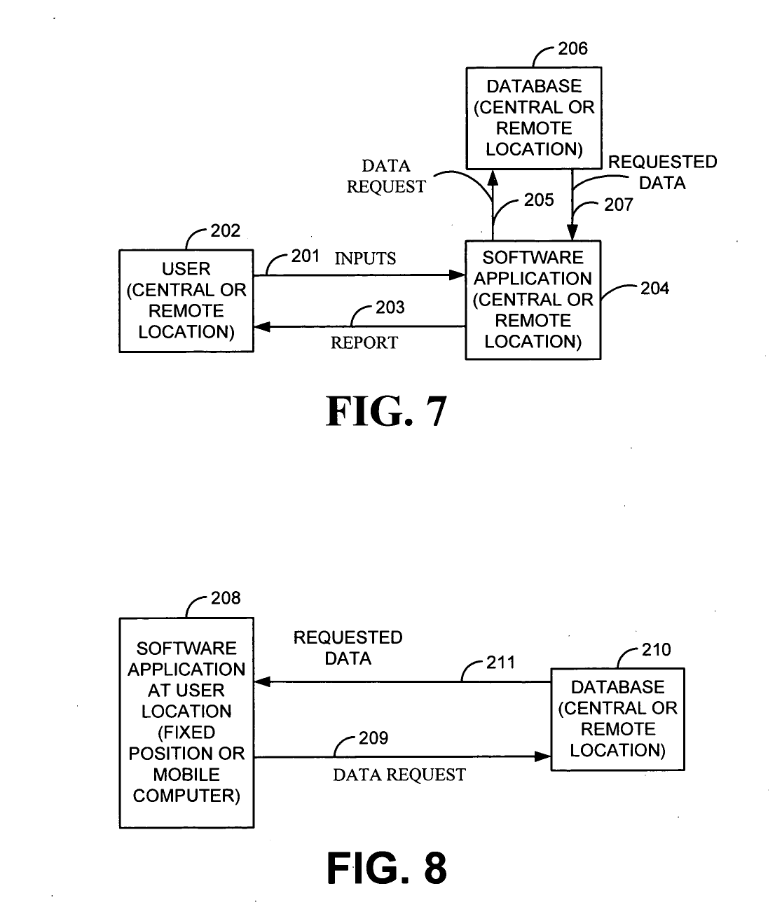

Reference is now made to FIG. 7, which is a block diagram illustrating an exemplary configuration of inputs and outputs for a software application as disclosed herein. A user designing an atmosphere-control-system is located at a user location 202. The user location 202 can include, but is not limited to, a user facility, a customer facility where the user is commissioned by the customer, a central location such as where a server-based software application resides, or any location remote to any of the above listed locations. For example, a user can use a mobile computing platform in conjunction with wireless or wired communication technology to access the software application 204 from virtually anywhere. The software application 204 can be centrally located at, for example, a provider's facility or can be provided for operation at a remote location through, for example, a distributed copy. Similarly, the database 206 can be centrally or remotely located from the software application 204 and the user 202. The user 202 provides inputs 201 to the software application 204, which requests data 205 from the database 206. The database 206 provides data 207 to the software application 204, which is then utilized to perform calculations, equipment selections, and report generation. The report 203 is provided by the software application 204 to the user 202 at the user's central or remote location.

Reference is now made to FIG. 8, which is a block diagram illustrating an alternative embodiment of an exemplary configuration of inputs and outputs for a software application, as disclosed herein. A software application 208 is located at a user location where the user location can be a fixed position or a mobile computing device. The database 210 is located at a central or remote location that can be different from that of the software application. The user inputs and the report generation are performed locally and a data request 209 is communicated to the database 210 through any combination of wired or wireless communication or network technologies. A database 210 provides the requested data 211 to the software application 208.

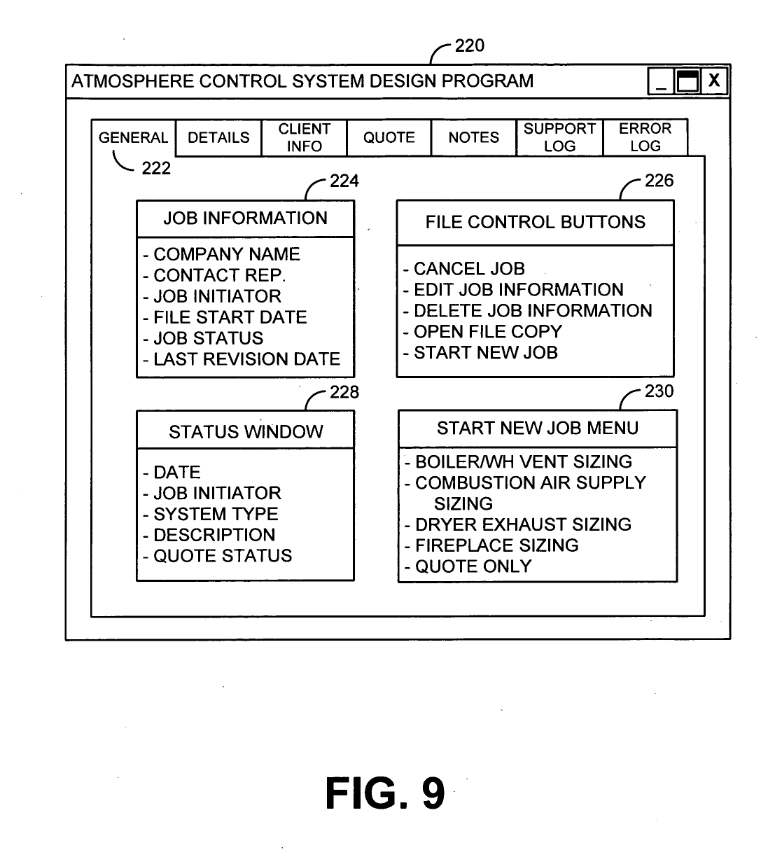

Reference is now made to FIG. 9, which is a block diagram illustrating an exemplary screen representation of an embodiment of an atmosphere-control-system design program general tab. The screen representation 220 includes multiple menu style tabs, each of which are configured to receive or display different types of information. The general tab 222 includes general information such as job information 224, file control buttons 226, a status window 228 and a start new job menu 230. The start new job menu 230 allows a user to select from job types including boiler or water heater vent sizing, combustion air supply sizing, dryer exhaust sizing, fireplace sizing, or a quote only. The file control buttons 226 include, but are not limited to, those configured to cancel a job, edit job information, delete job information, open a file copy and start a new job. The job information 224 located in the general tab 222 includes, but is not limited to, the company name, contact representative, job initiator, file start date, job status, and last revision date. Although not shown, the job information 224 can also include geographical information relating to the job and a unique job identifier. Also under the general tab 222, a status window 228 includes, but is not limited to, the date, a job initiator, a system type, a description, and a quote status, among others. While not shown, the general tab 222 can also include authorization or acknowledgement fields, order dates, and invoice information, among others.

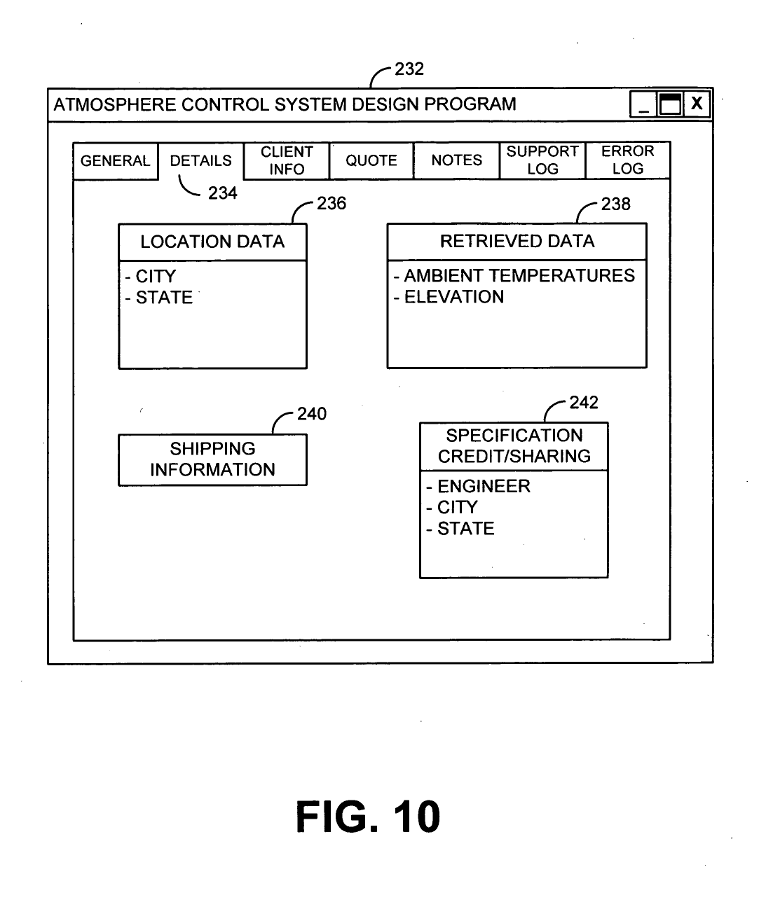

Reference is now made to FIG. 10, which is a block diagram illustrating an exemplary screen representation of an embodiment of an atmosphere-control-system design program details tab. The atmosphere-control-system design program screen 232 includes a details tab 234. The details tab 234 can include, but is not limited to, location data 236, retrieved data 238, shipping information 240, and specification credit/sharing information 242. The location data 236 can include, but is not limited to, the city and state where the proposed job is to be located. The retrieved data 238 includes, for example, ambient temperatures and elevation data corresponding to the geographical location. In addition to an outside standard temperature, the ambient temperatures can include ranges specified by industry standards organizations including, but not limited to, ASHRAE, for example. Specification credit/sharing information 242 can include specific information relating to an engineer or designer and their corresponding city and state. Although not shown, sharing information can include, for example, a company name and a contact name within the company.

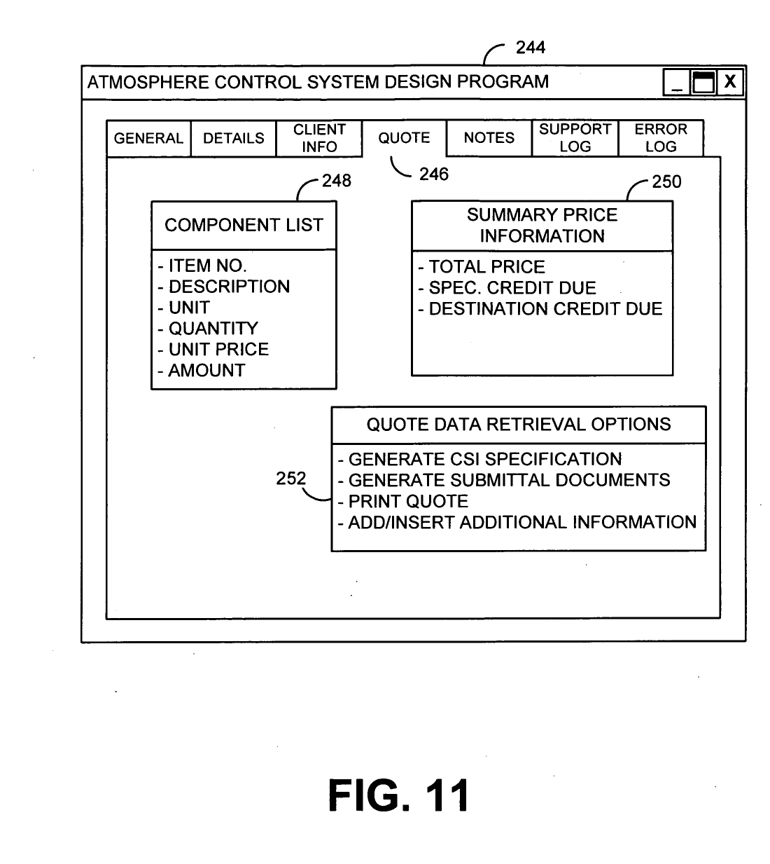

Reference is now made to FIG. 11, which is a block diagram illustrating an exemplary screen representation of an embodiment of an atmosphere-control-system design program quote tab. A quote tab 246 of an atmosphere-control-system design program screen 244 can include a component list 248, summary price information 250 and quote data retrieval options 252. The component list 248 can include, for each component listed, an item number, a description, unit of measure, quantity, unit price, and amount. The summary price information 250 can include a total price, a specification credit due, and a destination credit due. The quote data retrieval options 252 can include options to generate a Construction Specification Institute (CSI) specification, general submittal document, print a quote, or add/insert additional information. One of ordinary skill in the art knows or will know that CSI is an exemplary standards organization in the construction industry and that reports generated based on specifications of other standards organizations are contemplated within the scope and spirit of this disclosure. The CSI specification is a system description that can include different components, manufacture model numbers, and performance parameters. Submittal documents are those documents, which can be utilized when a contractor or subcontractor is submitting a bid for a construction job.

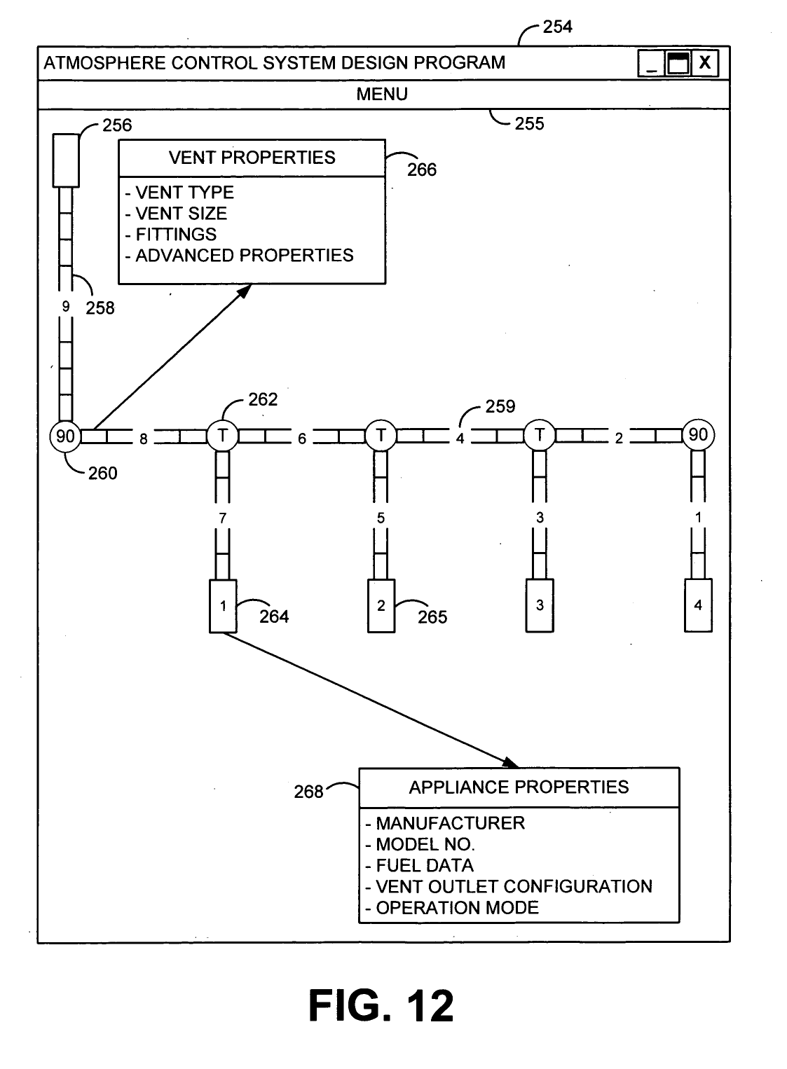

Reference is now made to FIG. 12, which is a block diagram illustrating an exemplary representation of an embodiment of an atmosphere-control-system design program system layout input screen. The atmosphere-control-system design program system layout screen 254 provides a graphically based computing environment for a user to communicate the physical layout, in dimensional characteristics, of a proposed control system. The user utilizes a menu 255, which can include, for example, pull-down menus or component icons to add structures that are to be included in the proposed system. The available structures include, but are not limited to, duct or vent 258, vent or draft control devices 256, appliances 264, and vent fittings including, but not limited to, 90° fittings 260 and T-fittings 262. Each section of vent or duct 258 can include a section length 259 and can be defined using multiple vent properties 266. The vent properties 266 can include vent type, vent size, fittings, and other advanced properties. Additionally the appliances 264 can be assigned unique identifiers 265, where each appliance can be further defined in terms of appliance properties 268. The appliance properties can include, but are not limited to, manufacturer, model number, fuel data, vent outlet configuration, and operation mode.

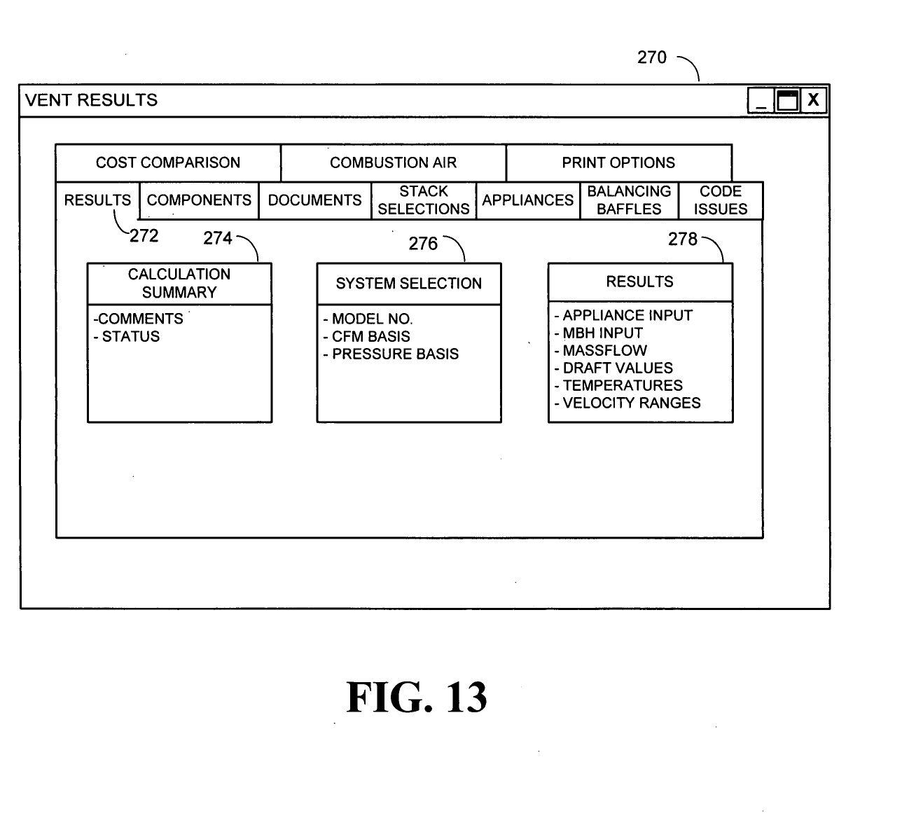

Reference is now made to FIG. 13, which is a block diagram illustrating an exemplary representation of an embodiment of a results tab on a vent results screen of an atmosphere, control system design program. The vent results screen 270 includes a result tab 272. The results tab 272 can include information such as calculation summary data 274, system selection information 276, and results 278. The calculation summary 274 can include comments and job status, among others. System selection information 276 can include model numbers of selected devices, CFM or cubic feet per minute basis of the system selection and the pressure basis of the system selection. The results data 278 can include appliance input, MBH input, mass flow, draft values, temperatures, and velocity ranges.

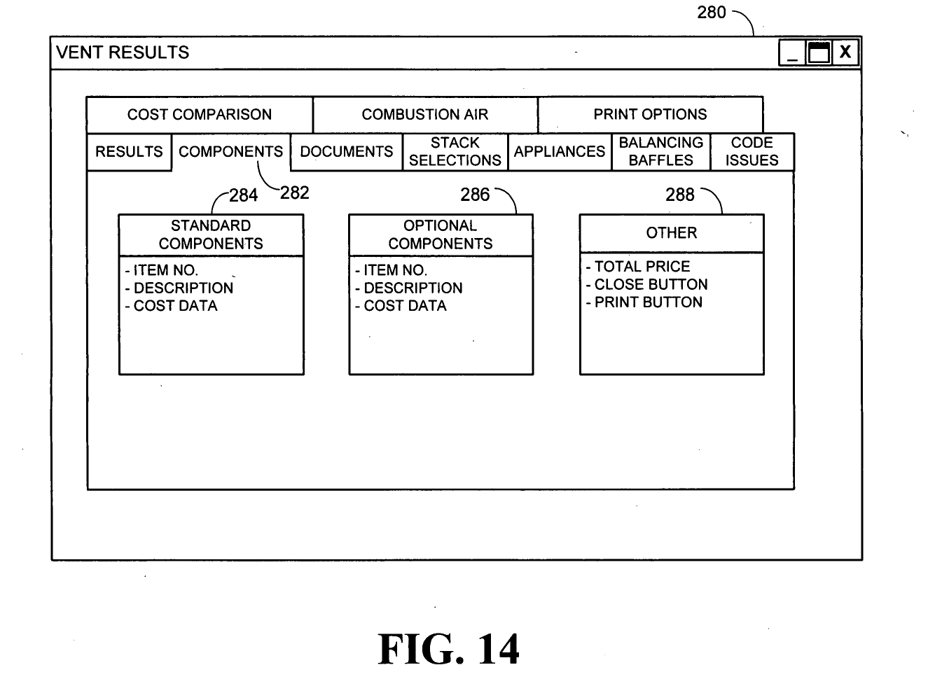

Reference is now made to FIG. 14, which is a block diagram illustrating an exemplary representation of an embodiment of a components tab on a vent results screen of an atmosphere-control-system design program. The vent results screen 280 includes a components tab 282, which includes standard components 284, options 286, and other related information 288. The standard components 284 information includes, but is not limited to, an item number, a description, and cost data. The cost data, for example, can include the unit purchased, quantity purchased, unit cost, and total cost per component type. Similarly, the optional components 286 can include item number, description, and cost data as well. Other screen content 288 can include a total price, a close button, and a print button.

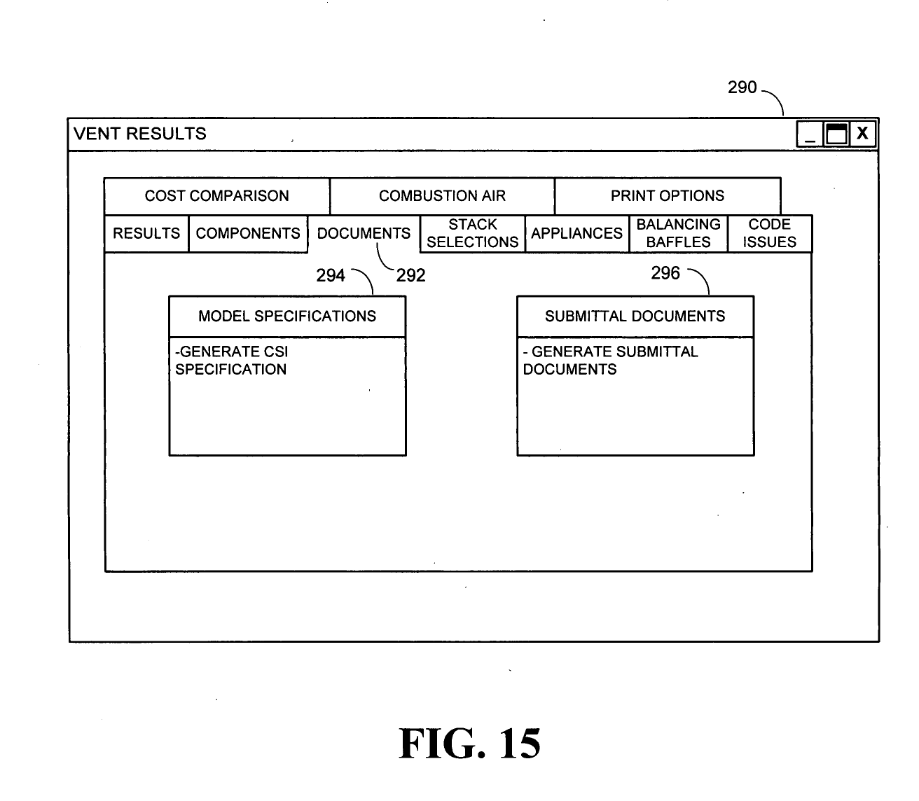

Reference is now made to FIG. 15, which is a block diagram illustrating an exemplary representation of an embodiment of a document tab on a vent results screen of an atmosphere-control-system design program. The results screen 290 includes a documents tab 292, which includes model specifications 294 and submittal documents 296. The model specifications 294 can include, for example, the option to generate a CSI specification in an electronic and/or printed format. While the CSI specification is a industry known standard, one of ordinary skill in the art will realize that model specifications 294 generated within the scope and spirit of this disclosure can be formatted to include data for any number of other specification standards or can be customized in accordance with other special requirements. Submittal document 296 can be generated in an electronic and/or printed format and provide a contractor, subcontractor, or other service provider, the documentation necessary to support a bid for providing a system corresponding the design provided.

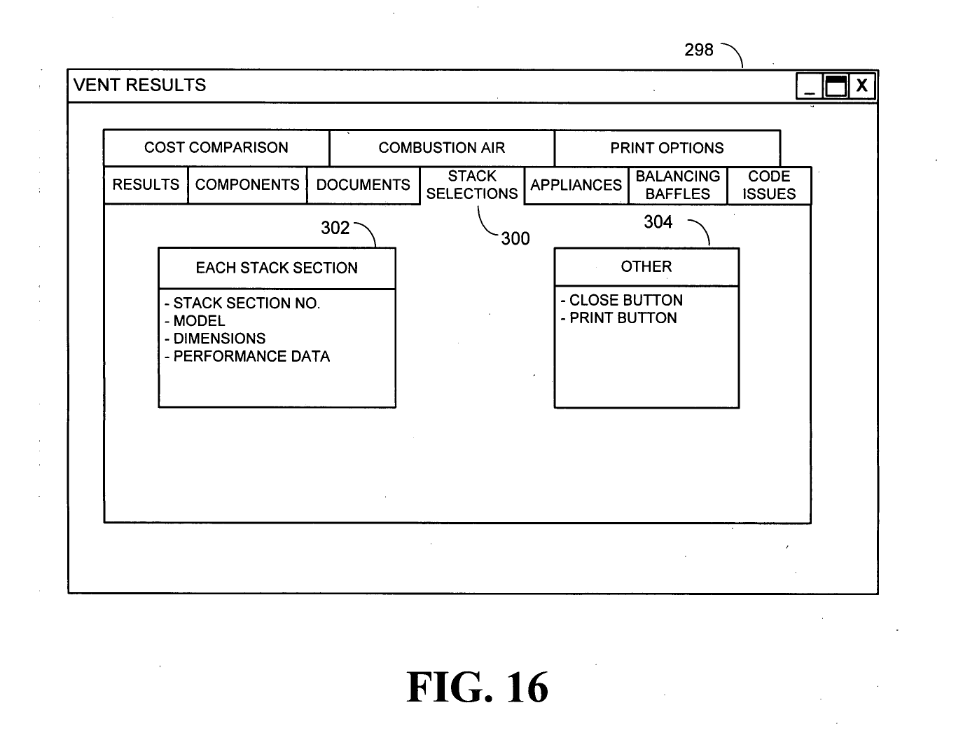

Reference is now made to FIG. 16, which is a block diagram illustrating an exemplary representation of an embodiment of a stack selections tab on a vent results screen of an atmosphere-control-system design program. The vent results screen 298 includes a stack selections tab 300, which displays data for each stack section 302. The data for each stack section 302 includes the stack section number, the model, dimensions, and performance data. The stack section number is determined by the stack identifier utilized in the proposed system layout as discussed above in reference to FIG. 12. The dimensions can include diameter and both vertical and horizontal lengths. For each stack section, performance data is also provided that can include, for example, weight, pounds per hour, velocity, temperature, percent CO₂ and other data related to pressure and flow characteristics. Additionally, the stack selection tab 300 includes other features 304 such as a close button and a print button.

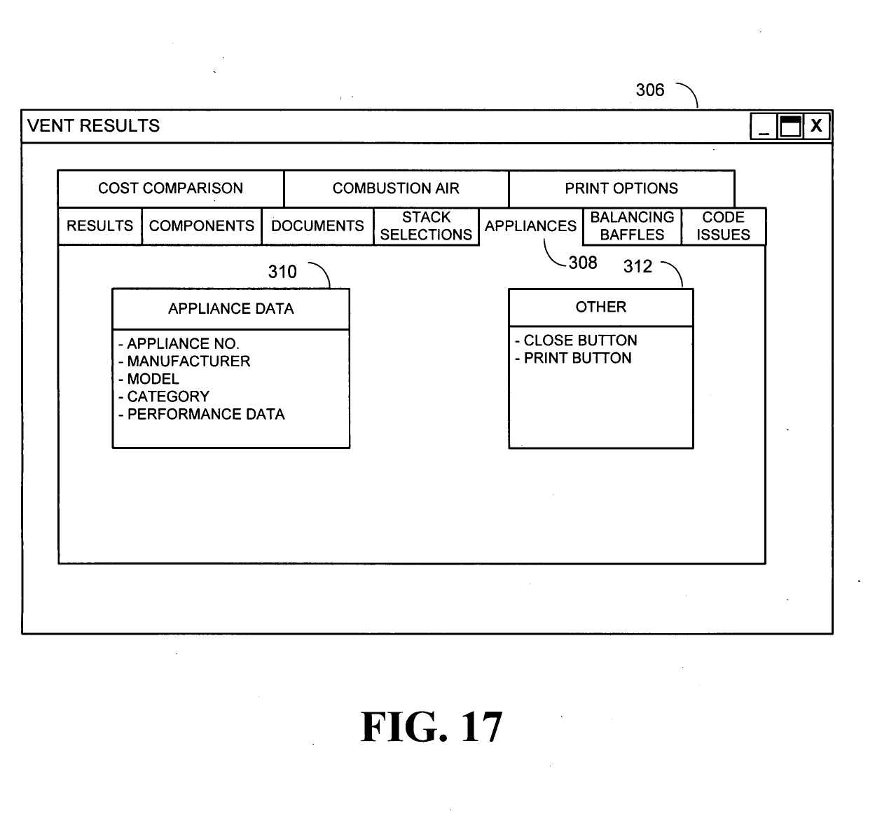

Reference is now made to FIG. 17, which is a block diagram illustrating an exemplary representation of an embodiment of an appliances tab on a vent results screen of an atmosphere-control-system design program. The appliances tab 308 on the vent results screen 306 includes appliance data 310, which can include, for each appliance, an appliance number, an appliance manufacturer and model number, a category, and performance data. The performance data can include, for example, fuel type, fuel consumption ranges, percent CO₂, temperature, and weight, in for example, pounds per hour. Additionally, the appliances tab 308 can include other features 312, such as a close button and a print button.

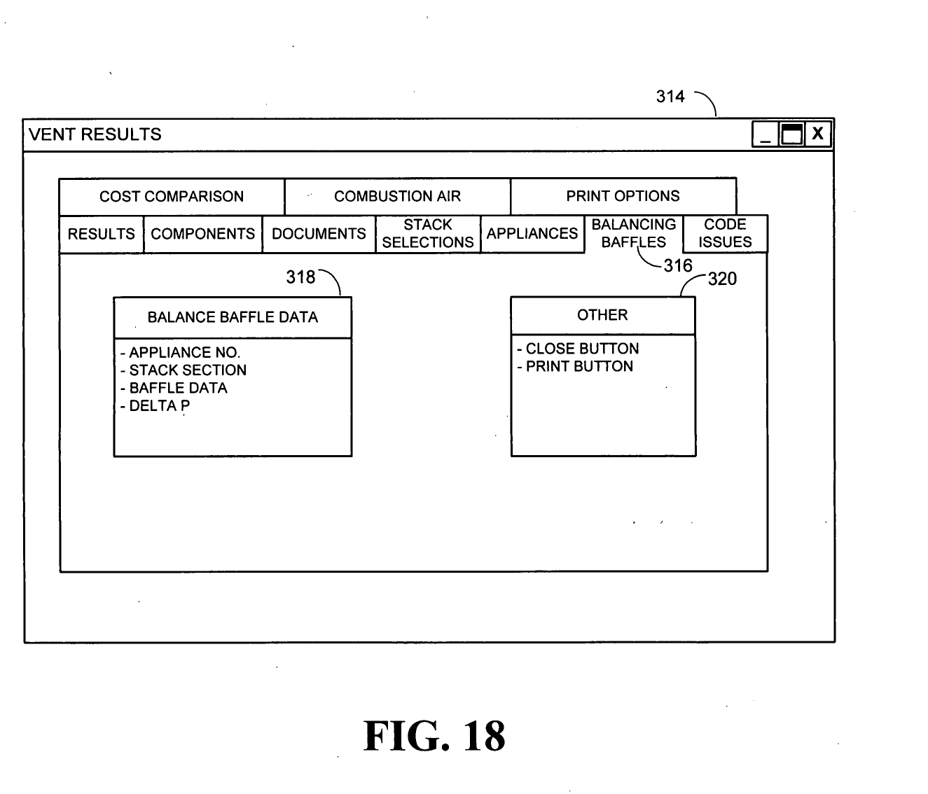

Reference is now made to FIG. 18, which is a block diagram illustrating an exemplary representation of an embodiment of a balancing baffles tab on a vent results screen of an atmosphere-control-system design program. The balancing baffles tab 316 on the vent results screen 314 includes balancing baffle data 318. The balancing baffle data 318 includes baffle information for each appliance as listed by appliance number. Corresponding to each appliance number, the stack section of baffle type, and the AP or difference in pressure, are listed. Included in the baffle data are the diameter and baffle types. Additionally or optionally, the baffle setting may be provided for each baffle. Other features 320 on the balancing baffles tab includes a close button and a print button.

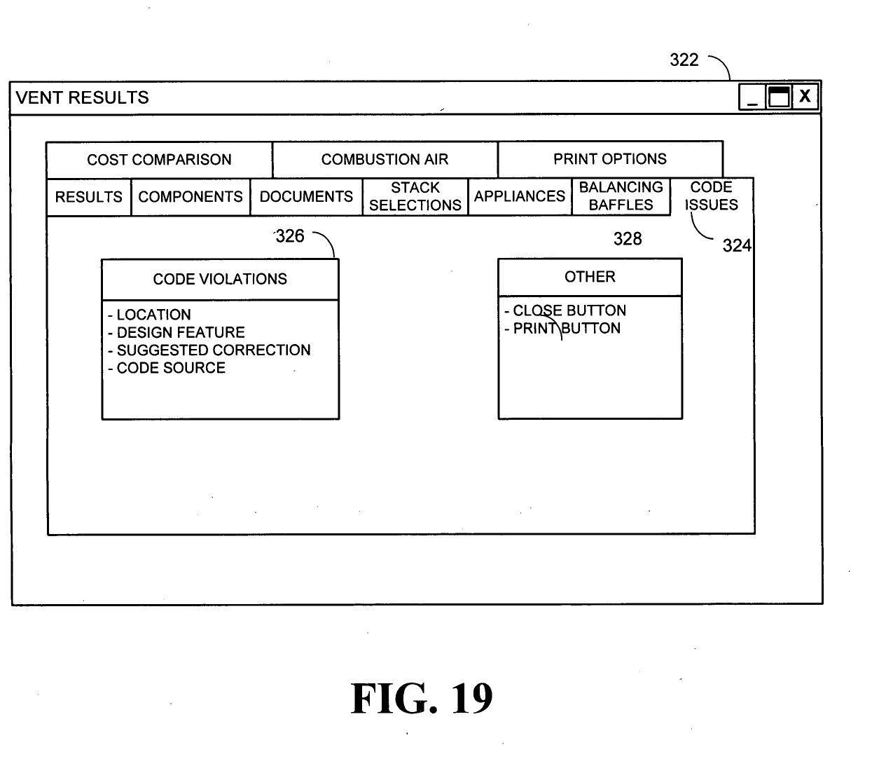

Reference is now made to FIG. 19, which is a block diagram illustrating an exemplary representation of an embodiment of a code issues tab on a vent results screen of an atmosphere-control-system design program. The code issues tab 324 on the vent results screen 322 includes code violations 326, which can include information such as the location of a violation, the design feature associated with the violation, and a suggested correction. Additionally, the specific code provision and the code source can also be included. The code issues tab 324 can also include other features 328 that include, for example, a close button and a print button.

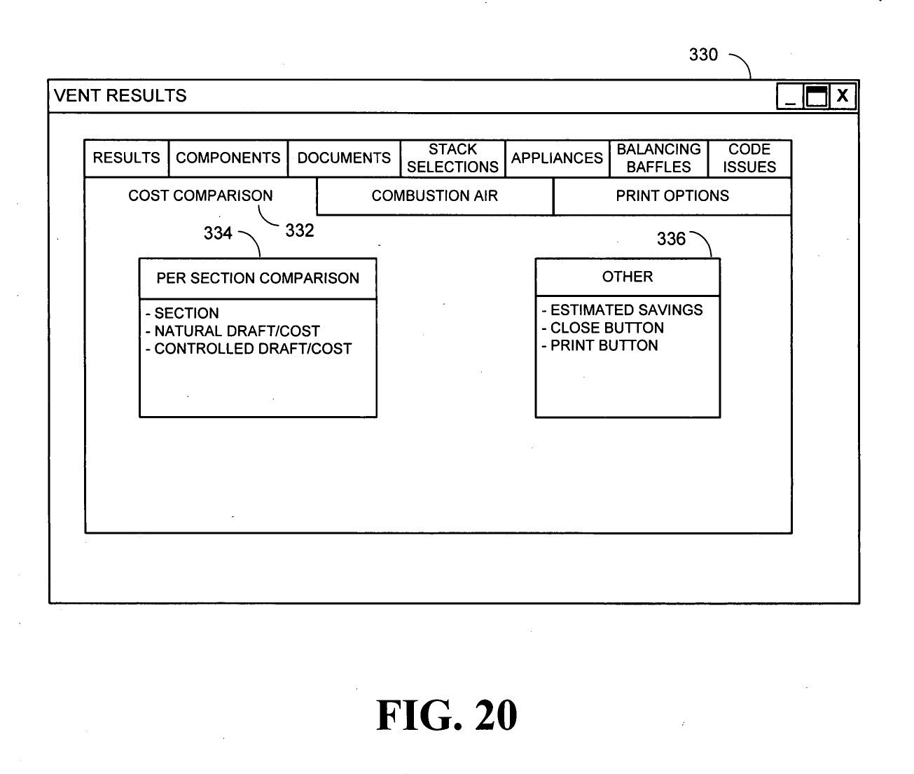

Reference is now made to FIG. 20, which is a block diagram illustrating an exemplary representation of an embodiment of a cost comparison tab on a vent results screen of an atmosphere-control-system design program. The cost comparison tab 332 on the vent results screen 330 includes a per section comparison 334, which identifies the section number, the cost for each component in a natural draft system and the cost for each component in a controlled draft system. In addition to identifying each section by number, the description of each section in the corresponding natural draft and controlled draft systems is provided. Additionally, the cost comparison tab 332 can have other features 336, including, for example, estimated savings based on a control draft system, a close button, and a print button.

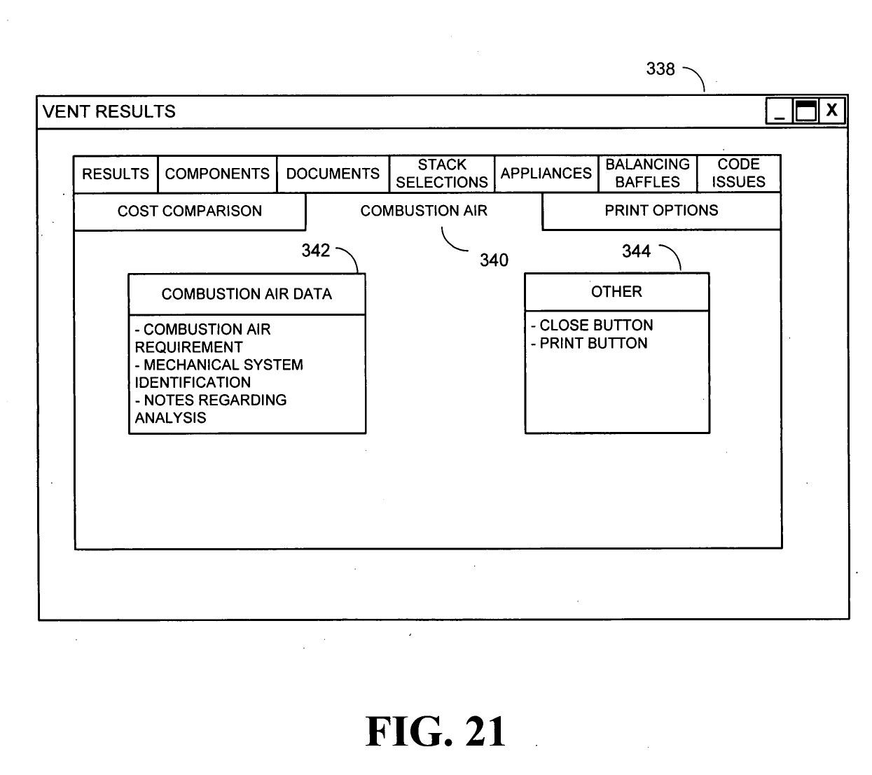

Reference is now made to FIG. 21, which is a block diagram illustrating an exemplary representation of an embodiment of a combustion air tab on a vent results screen of an atmosphere-control-system design program. A combustion air tab 340 on the vent results screen 338 includes combustion air data 342, which can include the combustion air requirement for the system, mechanical system identification, and notes regarding the analysis or the assumptions upon which the analysis was based. Additionally, the combustion air tab 340 includes other features 344 such as a close button and a print button.

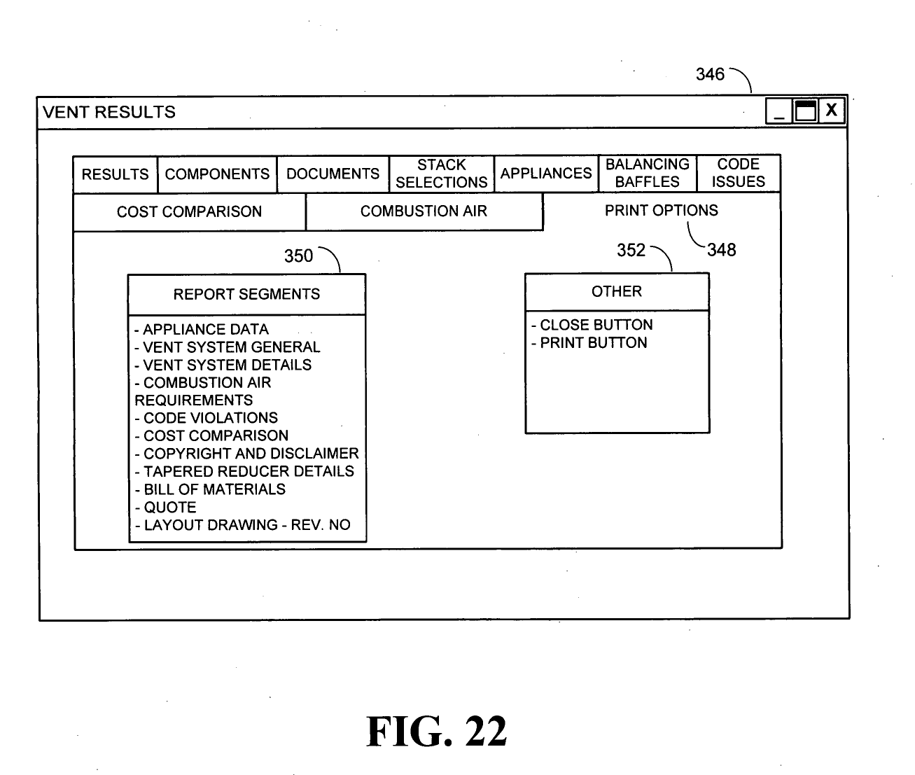

Reference is now made to FIG. 22, which is a block diagram illustrating an exemplary representation of an embodiment of a print options tab on a vent results screen of an atmosphere-control-system design program. The print options tab 348 on the vent results screen 346 includes report segments 350, which can individually be selected for optional inclusion into a final report. The report segment 315 can include appliance data, vent system general data, vent system details, combustion air requirements, code violations, cost comparisons, copyright and disclaimer, details regarding any tapered reducers, bill of materials, quote, and a layout drawing revision number. Additionally the print options tab 348 can include other features 352, such as a close button and a print button.

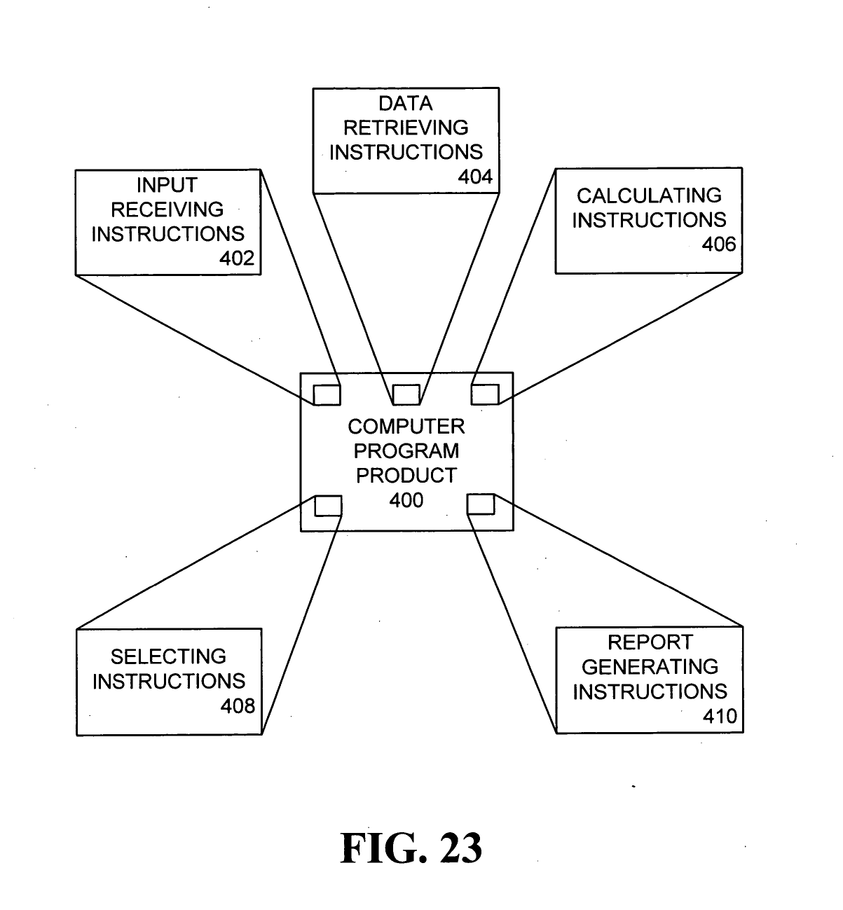

Reference is now made to FIG. 23, which is a block diagram illustrating an exemplary embodiment of a computer program product as disclosed herein. The computer program product 400 includes input receiving instructions 402, data retrieving instructions 404, calculating instructions 406, selecting instructions 408 and report generating instructions 410.

The input receiving instructions 402 are configured to receive inputs, corresponding to a proposed atmosphere-control-system from a user. The inputs can include, but are not limited to, geographical location of the proposed control system, the quantity of appliances used in the system, appliance specific data, and system dimensional information corresponding to the system. The instructions may be received from a user local to the computer program product 400 or from a user remotely located from the computer program product 400. A remotely located user can communicate the inputs to the computer program product 400 utilizing any number of technologies including any combination or wired and/or wireless communication or network techniques.

The data retrieving instructions 404 are configured to retrieve, from a database, data that is responsive to the inputs provided by the user. For example, when a user provides a geographical location the computer program product 400 can retrieve elevation and ambient temperature data corresponding to that location. Similarly, where the user inputs include information regarding specific appliances, the computer program product 400 can retrieve appliance-specific performance data for each of the appliances from the database. While the database can be located proximate to the computer program product 400, the database also can be located on a separate computing device that is remote from either the computer program product 400 or the user providing the inputs.

The calculating instructions 406 are configured to calculate a variety of system performance values based on the input data received from the user and the corresponding data retrieved from the database. The performance values can include, but are not limited to volume, pressure, velocity, and the requisite component sizes corresponding to system requirements. The selecting instructions 408 are configured to select system components based on the values calculated by the calculating instructions 406.

The report generating instructions 410 are configured to generate one or more reports for a user. Reports can be generated in an electronic format, a printed format, or some combination thereof, and can include any or all of the following types of information: appliance data; system general information; system detailed information; combustion air requirements; code violations; cost comparisons; copyright and disclaimer information; tapered reducer details; bill of materials; job or equipment quote; and layout drawings, among others.

Additionally, the computer program product 400 can provide programming parameters for control system components (not shown). In some embodiments, the control system components are programmed by a manufacturer, distributor, or other type of system provider. In other embodiments, the control system components are programmed remotely by the computer program product. The remote programming can be accomplished using any number of communication or network technologies or protocols including wireless, wired, or some combination thereof.

Embodiments of the present disclosure can be implemented in hardware, software, firmware, or a combination thereof. Some embodiments can be implemented in software or firmware that is stored in a memory and that is executed by a suitable instruction execution system. If implemented in hardware, an alternative embodiment can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of an embodiment of the present disclosure in which functions may be executed out of order from that shown or discussed, including substantially concurrently or in reverse order, depending on the functionality involved, as would be understood by those reasonably skilled in the art of the present disclosure.

The atmosphere control design program, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the present disclosure includes embodying the functionality of the illustrated embodiments of the present disclosure in logic embodied in hardware or software-configured mediums.

It should be emphasized that the above-described embodiments of the present disclosure, particularly, any illustrated embodiments, are merely possible examples of implementations. Many variations and modifications may be made to the above-described embodiments of the disclosure. All such modifications and variations are intended to be protected by the following claims.

At least the following is claimed:

1. A computer readable medium having a computer program for providing an atmosphere-control-system design, the program for performing the steps of:
validating an identity of a user;
receiving, from the user, a geographical location of a proposed atmospheric control system;
receiving, from the user, a quantity of appliances in the proposed atmospheric control system;
receiving, from the user, appliance-specific data;
receiving, from the user, system dimensional information corresponding to the proposed atmospheric control system;
retrieving, from a database, an elevation corresponding to the geographical location;
retrieving, from the database, ambient temperature data corresponding to the geographical location;
retrieving, from the database, a plurality of appliance characteristics;
calculating volume, pressure, and velocity values of the proposed atmospheric control system based on at least one of the plurality of appliance characteristics and the system dimensional information;
calculating a system component diameter;
calculating a system component resistance;
calculating an estimated system draft value based on ambient temperature data, system dimensional information, and the elevation;
selecting a plurality of system components; and
generating a report having an equipment listing for the proposed atmospheric control system;
generating a report having a cost estimate submission document, configured to include documentation corresponding to a bid for providing the proposed atmospheric control system;
generating a report having a list of code violations configured to include information corresponding to a violation of federal, state or local code provisions; and
generating a report having a vent cost comparison, configured to include comparative data corresponding to an alternative system design.

2. A method for providing an atmosphere-control-system design using computer software, comprising:
receiving a plurality of inputs, corresponding to a proposed atmospheric control system, from a user;
retrieving data, corresponding to the plurality of inputs, from a database;
calculating a plurality of performance parameters, utilizing the plurality of inputs and the data;
selecting a plurality of system components for the atmosphere control system and corresponding to the plurality of performance parameters; and
generating a report for the user, the report comprising design data corresponding to the plurality of system components, the plurality of performance parameters, the data, and the plurality of inputs.

3. The method of claim 2, wherein receiving a plurality of inputs comprises receiving a geographic location of the proposed atmospheric control system.

4. The method of claim 2, wherein receiving a plurality of inputs comprises receiving a quantity of appliances of the proposed atmospheric control system.

5. The method of claim 2, wherein receiving a plurality of inputs comprises receiving appliance specific data.

6. The method of claim 5, wherein receiving appliance specific data comprises receiving manufacturer identification data.

7. The method of claim 2, wherein receiving a plurality of inputs comprises receiving vent topology where the proposed atmospheric control system is an appliance venting system.

8. The method of claim 7, wherein receiving vent topology comprises receiving a vent section height.

9. The method of claim 7, wherein receiving vent topology comprises receiving a vent section length.

10. The method of claim 2, wherein receiving a plurality of inputs comprises receiving a duct configuration where the proposed atmospheric control system is a combustion air supply system.

11. The method of claim 10, wherein receiving a duct configuration comprises receiving a quantity of duct directional changes.

12. The method of claim 2, wherein receiving a plurality of inputs comprises receiving a flue configuration where the proposed atmospheric control system is a fireplace vent system.

13. The method of claim 2, wherein receiving a plurality of inputs comprises receiving fireplace dimensional data where the proposed atmospheric control system is a fireplace vent system.

14. The method of claim 2, wherein retrieving data from a database comprises retrieving geographical elevation data.

15. The method of claim 2, wherein retrieving data from a database comprises retrieving ambient temperature data.

16. The method of claim 2, wherein retrieving data from a database comprises retrieving appliance characteristics.

17. The method of claim 2, wherein retrieving data from a database comprises retrieving vent characteristics where the proposed atmospheric control system is an appliance venting system.

18. The method of claim 2, wherein retrieving data from a database comprises retrieving duct characteristics where the proposed atmospheric control system is a dryer exhaust system.

19. The method of claim 2, wherein retrieving data from a database comprises retrieving flue characteristics where the proposed atmospheric control system is a fireplace vent system.

20. The method of claim 2, wherein calculating a plurality of performance parameters comprises calculating values selected from the group comprising: volume, pressure, and velocity.

21. The method of claim 2, wherein calculating a plurality of performance parameters comprises calculating a system component diameter.

22. The method of claim 2, wherein generating a report for the user comprises providing an equipment listing for the proposed atmospheric control system.

23. The method of claim 2, further comprising generating a control parameter corresponding to a control component in the proposed atmospheric control system.

24. The method of claim 2, further comprising validating an identity of a user.

25. A computer program product, in a computer readable medium, for providing design data for an atmosphere-control-system, comprising:
instructions configured to receive a plurality of inputs from a user;
instructions configured to retrieve, from a database, data corresponding to the plurality of inputs;
instructions configured to calculate a variety of system performance values;
instructions configured to select a plurality of system components; and
instructions configured to generate a report for the user.

26. The computer program product of claim 25, wherein the parameter is utilized in a programmable a control system component.

27. The computer program product of claim 25, further comprising instructions configured to provide a user interface.

28. The computer program product of claim 27, wherein the user interface comprises a graphical user interface.

29. The computer program product of claim 25, wherein the report comprises a bid submission document.

30. The computer program product of claim 25, wherein the report comprises a listing of violations of system installation ordinances.

31. The computer program product of claim 25, wherein the report comprises report in accordance with an industry standards organization.

32. The computer program product of claim 31, wherein the industry standards organization is the Construction Standards Institute.

33. The computer program product of claim 25, wherein the user is located remotely from a location running the computer program product.
